(19) United States
(12) Patent Application Publication
(10) Pub. No.: US 2023/0229817 A1
(43) Pub. Date: Jul. 20, 2023

(54) SECURED PORTABLE DATA STORAGE DEVICE

(71) Applicant: CYBER RIDER LTD., Gan-Yoshiya (IL)

(72) Inventor: Eshed KREINER, Gan-Yoshiya (IL)

(21) Appl. No.: 17/579,605

(22) Filed: Jan. 20, 2022

(51) Int. Cl. G06F 21/78

(52) U.S. Cl. CPC G06F 21/78

(57) ABSTRACT

A secured portable data storage device configured to mechanically detachably connect to a host computing device and receive power from the host computing device, the secured portable data storage device includes: at least one memory unit configured to store data and a mechanical disconnection mechanism adapted to physically and selectively change connection states of at least one of (a) a power circuit, or (b) a data circuit, thereby prevent unauthorized access to the memory unit, wherein the mechanical disconnection mechanism is operable independently of receipt of the power from the host computing device.

### TECHNICAL FIELD

The invention relates to a secured portable data storage device.

### BACKGROUND

Portable data storage devices (e.g., a USB flash drives, portable drivers, etc.) have many advantages compared to other computer storage devices (e.g., desktop computer internal hard disk drives) and are very useful when data needs to be transported from one place to another or when a computer backup needs to be performed so that in case the original data is lost or becomes unusable it can be restored. Data loss can be caused by a variety of things such as computer viruses, hardware failure, file corruption, theft, etc.

When the portable data storage device (e.g., a USB flash drive, portable driver, etc.) is plugged in to a working computer for example, malware that obtains access to the computer (for any reason, for example by performing a ransomware attack or performing a data theft) can also obtain access to the data stored on the portable data storage device. One way of avoiding this is to remove the external storage device immediately following backup. However, this increases the risk that the external storage device will be misplaced. Moreover, constant plugging and unplugging may wear out the portable data storage device and affect life expectancy thereof.

Therefore, there is a growing need to provide a secured portable data storage device.

References considered to be relevant as background to the presently disclosed subject matter are listed below. Acknowledgement of the references herein is not to be inferred as meaning that these are in any way relevant to the patentability of the presently disclosed subject matter.

US Patent Application No. US20080215841A1 published on Sep. 4, 2008 discloses a memory lock system that includes: providing a controller; providing a connector connected to the controller for providing data to the controller; providing a memory connected to the controller for receiving and storing information from the controller; and manipulating an input device connected to the controller to unlock or lock data transfer between the connector and the controller, in the controller, between the connector and the memory, or in the memory.

US Patent Application No. US20150082422A1 published on Mar. 19, 2015 discloses a system and method for securing a personal device that includes a device core and a peripheral device from unauthorized access or operation. The system comprises an isolated switch, included fully or partially within an envelope of the personal device. The isolated switch cannot be affected in its operation by either the device core or the peripheral device. The switch may be operated by an authorized user of the personal device either preemptively or in response to a detected threat. In some embodiments, the isolated switch includes an isolated controller which can send one or more signals to the peripheral device and/or part of peripheral device. In some embodiments, the isolated switch includes an isolated internal component and an isolated external component, both required to work together to trigger the isolated switch operation. In some embodiments, the isolated switch includes an isolated disconnector for connecting and disconnecting the device core from part of the peripheral device.

US Patent Application No. US20170017810A1 published on Jan. 19, 2017 discloses a data security system, and a method of operation thereof, includes a data security transceiver or receiver; an authentication subsystem operatively connected to the data security transceiver or receiver; and a storage subsystem connected to the authentication subsystem.

US Patent Application No. US20020010827A1 published on Jan. 24, 2002 discloses a portable data storage device includes a universal serial bus (USB) coupling device and an interface device is coupled to the USB coupling device. The portable data storage device also includes a memory control device and a non-volatile solid-state memory device. The memory control device is coupled between the interface device and the memory device to control the flow of data from the memory device to the USB coupling device.

### GENERAL DESCRIPTION

In accordance with a first aspect of the presently disclosed subject matter, there is provided a secured portable data storage device configured to mechanically detachably connect to a host computing device and receive power from the host computing device, the secured portable data storage device comprising: at least one memory unit configured to store data; and a mechanical disconnection mechanism adapted to physically and selectively change connection states of at least one of (a) a power circuit, or (b) a data circuit, thereby prevent unauthorized access to the memory unit, wherein the mechanical disconnection mechanism is operable independently of receipt of the power from the host computing device.
In some cases, the connection state includes a connected state and a disconnect state.
In some cases, the selective change of the connection states is done by opening or closing at least one of: (a) the power circuit, or (b) the data circuit.
In some cases, the mechanical disconnection mechanism is configured to be operated by a user.
In some cases, the data stored by the memory unit is encrypted.
In some cases, the disconnecting mechanism is one of: a thumb wheel, a switch, a knob, or a button.
In some cases, host computing device is one of: a desktop computer, portable personal computer (PC), a tablet PC, a handheld PC, a server, a smart television, or a smartphone, or an IOT device.
In some cases, the secured portable data storage device further comprising a visual indicator configured to indicate the connection state.
In some cases, the visual indicator is a Light Emitting Diode.
In some cases, the Light Emitting Diode is on in the connected state and off in the disconnected state.
In some cases, the Light Emitting Diode is further configured to provide light in different colors, in accordance with the connection state, so that a first color of the different colors is indicative of a first connection state and a second color of the different colors is indicative of a second connection state.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 depicts a block diagram of one example of a secured portable data storage device in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “changing” or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

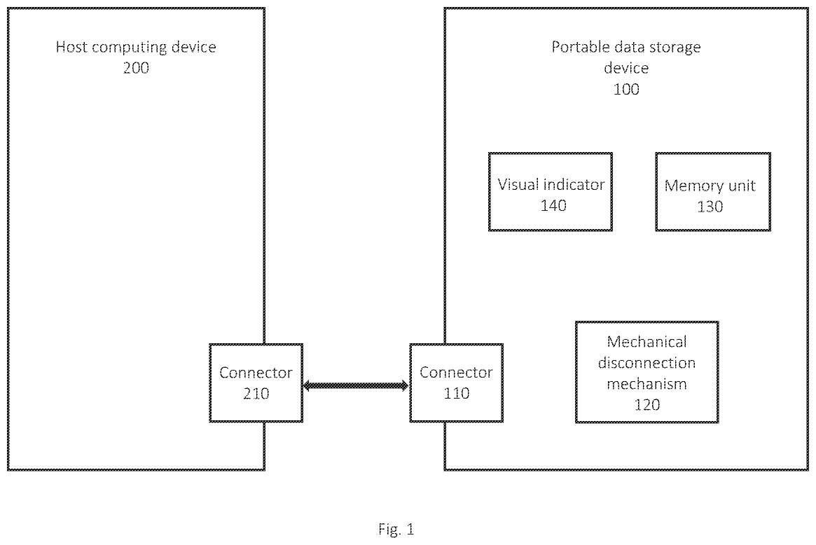

A secured portable data storage device and a host computing device according to the presently disclosed subject matter are illustrated in FIG. 1.

As shown in FIG. 1, a secured portable data storage device 100 and a host computing device 200 can connect through connectors as further described herein below. The host computing device 200 includes a connector 210. The secured portable data storage device 100 includes at least one memory unit 130 and a mechanical disconnection mechanism 120.

The secured portable data storage device 100 can further include a connector 110 configured to mechanically detachably connect to the host computing device 200 and receive power therefrom. The connector 110 may be for example a Universal Serial Bus (USB) connector and the connector 210 may be a mating receptacle thereof, so that connector 110 can be plugged into connector 210. In other cases, the connection between the secured portable data storage device 100 and the host computing device 200 can be established through cabling means, e.g., a USB cable that is configured to connect to connector 110 at one end thereof and to connector 210 at the other end thereof.

The host computing device 200 can be for example a desktop computer, portable personal computer (PC), a tablet PC, a handheld PC, a server, a smart television, a smartphone, an IOT device or any other means configured to perform actions according to the presently disclosed subject matter.

Referring back to the secured portable data storage device 100, the memory unit 130 comprised therein can be configured to, inter alia, store data received from the host computing device 200 through connector 110. It can be, for example and without limitation, a nonvolatile memory storage media including semiconductor-based memory units such as FLASH memory, EEPROM, EPROM, ROM, ferromagnetic digital memories, ferroelectric RAM, MRAM, CBRAM, PRAM, SONOS, RRAM, Racetrack memory, NRAM, Millipede, etc.

In some cases, data stored by the memory unit 130 can be encrypted in order to add additional layer of security to the secured portable data storage device 100 disclosed herein.

The mechanical disconnection mechanism 120 can be adapted to physically and selectively change connection states of at least one of (a) a power circuit, or (b) a data circuit, of the secured portable data storage device 100 and thereby prevent unauthorized access to the memory unit 130, while the secured portable data storage device 100 is connected to the host computing device 200. Whereas the secured portable data storage device 100 is configured to receive power from the host computing device 200, while being connected thereto, the mechanical disconnection mechanism 120 is configured to be operated independently of receipt of the power from the host computing device 200. For this purpose, the disconnecting mechanism 120 is configured to be operated by a user and can be for example one of: a thumb wheel, a switch, a knob, a button, or any other mechanical means that can be configured to be operable according to the presently disclosed subject matter.

The connection states that are being physically and selectively changed by the mechanical disconnection mechanism 120 can include a connected state and a disconnect state. The selective change of the connection states can be done by opening or closing at least one of: (a) the power circuit, or (b) the data circuit. For example, the user connects the secured portable data storage device 100 to the host computing device 200, through connectors 110 and 210 as previously described herein, and stores data on the secured portable data storage device 100, e.g., for data backup purposes in order to be able for example to recover the data after its loss from data deletion or corruption, or to recover the data from an earlier time. Upon completing the backup process, the user can physically operate the mechanical disconnection mechanism 120, e.g., by pressing a button in case where the mechanical disconnection mechanism 120 is a button for example, and thereby change the connection state of the power circuit or the data circuit or both. During the data transfer between the secured portable data storage device 100 and the host computing device 200 while they are being connected therebetween, the power circuit and the data circuit are in connected state, i.e., the power circuit and the data circuit each are closed. Once the data transfer process has been completed, the user physically operates the mechanical disconnection mechanism 120 that changes the connection state of the power circuit or the data circuit or both from connected state to disconnected state. In the disconnected state, the power circuit or the data circuit or both are open circuits. When at least one of the power circuit or the data circuit is disconnected, the secured portable data storage device 100 cannot be accessed from the host computing device 200, while being connected thereto. In fact, the mechanical disconnection mechanism 120 obviates the need for physically disconnecting (e.g., unplugging) the secured portable data storage device 100 from the host computing device 200 when it is not in use. This may decrease the risk of misplacing the secured portable data storage device 100 and extend the life expectancy thereof as constant plugging and unplugging may wear out the secured portable data storage device 100 eventually sooner than expected.

The secured portable data storage device 100 can further include a visual indicator 140, e.g., a Light Emitting Diode (LED), that can be configured, for example and without limitation, to indicate the connection state of at least one of (a) a power circuit, or (b) a data circuit comprised by the secured portable data storage device 100. Visual indication of the connection state can be provided by the LED for example in the following manner the LED can be on when at least one of the power circuit, or the data circuit is in the connected state and the LED can be off when at least one of the power circuit, or the data circuit is off in the disconnected state.

According to certain examples of the presently disclosed subject matter, the LED can be further configured to provide light in different colors, in accordance with the connection state, so that a first color of the different colors is indicative of a first connection state and a second color of the different colors is indicative of a second connection state. For example, the LED can provide light in first color when at least one of the power circuit, or the data circuit is in the connected state and provide light in second color when at least one of the power circuit, or the data circuit is in the disconnected state, wherein the first color is different from the second color. In some cases, the LED can provide light in various manners, such as but not limited to, a constant light, a light with varying illumination intensities, a varying color light (i.e., the color may vary in a predetermined manner), a predetermined pattern of light, a flashing light with a predetermined frequency (e.g., a high flashing frequency can be used for cases wherein at least one of the power circuit, or the data circuit is in the disconnected state after the user physically operated the mechanical disconnection mechanism 120 to change the connection state from disconnected state to connected state), and/or combination(s) thereof where applicable. In some cases, the color of the light provided by the LED can be indicative of a malfunction of one or more components comprised by the secured portable data storage device 100 (e.g., a certain color may indicate that there is a failure to function of the secured portable data storage device 100, while in other cases a certain color may indicate that a specific component comprised by the secured portable data storage device 100 has failed to function, for example and without limitation, the LED can provide a red light in cases where the connector 110 is not working properly (for example when it was not plugged in properly to connector 210) and the LED can provide a blue light in cases where the data circuit is open when it should be closed, in accordance with the presently disclosed subject matter. Such operation modes of the LED can be adjusted to user's requirements and/or needs. In some cases, specific/desired operation modes of the LED can be chosen by the user from a list of settings provided with the secured portable data storage device 100.

It is to be noted that according to additional examples of the presently disclosed subject matter, more than one LED can be comprised by the secured portable data storage device 100, wherein each LED can be configured to perform, inter alia, functions disclosed herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A secured portable data storage device configured to mechanically detachably connect to a host computing device and receive power from the host computing device, the secured portable data storage device comprising:
at least one memory unit configured to store data; and
a mechanical disconnection mechanism adapted to physically and selectively change connection states of at least one of (a) a power circuit, or (b) a data circuit, thereby prevent unauthorized access to the memory unit, wherein the mechanical disconnection mechanism is operable independently of receipt of the power from the host computing device.

2. The secured portable data storage device of claim 1, wherein the connection state includes a connected state and a disconnect state.

3. The secured portable data storage device of claim 1, wherein the selective change of the connection states is done by opening or closing at least one of: (a) the power circuit, or (b) the data circuit.

4. The secured portable data storage device of claim 1, wherein the mechanical disconnection mechanism is configured to be operated by a user.

5. The secured portable data storage device of claim 1, wherein the data stored by the memory unit is encrypted.

6. The secured portable data storage device of claim 1, wherein the disconnecting mechanism is one of: a thumb wheel, a switch, a knob, or a button.

7. The secured portable data storage device of claim 1, wherein the host computing device is one of: a desktop computer, portable personal computer (PC), a tablet PC, a handheld PC, a server, a smart television, or a smartphone, or an IOT device.

8. The secured portable data storage device of claim 2, further comprising a visual indicator configured to indicate the connection state.

9. The secured portable data storage device of claim 8, wherein the visual indicator is a Light Emitting Diode.

10. The secured portable data storage device of claim 9, wherein the Light Emitting Diode is on in the connected state and off in the disconnected state.

11. The secured portable data storage device of claim 9, wherein the Light Emitting Diode is further configured to provide light in different colors, in accordance with the connection state, so that a first color of the different colors is indicative of a first connection state and a second color of the different colors is indicative of a second connection state.
